(19) United States
(12) Patent Application Publication
(10) Pub. No.: US 2024/0362196 A1
(43) Pub. Date: Oct. 31, 2024

(54) REAL-TIME FEATURE STORE IN A DATABASE SYSTEM

(71) Applicant: Snowflake Inc., Bozeman, MT (US)

(72) Inventors: Sandeep Narendra Gupta, Pleasanton, CA (US); Qiming Jiang, Redmond, WA (US)

(21) Appl. No.: 18/490,586

(22) Filed: Oct. 19, 2023

Related U.S. Application Data
(60) Provisional application No. 63/498,916, filed on Apr. 28, 2023.

(51) Int. Cl. G06F 16/22; G06F 16/242; G06F 16/2455

(52) U.S. Cl. CPC G06F 16/2282; G06F 16/2448; G06F 16/24568

(57) ABSTRACT

Provided herein are systems and methods for real-time feature store configuration. The method includes decoding raw data received from a data source to obtain decoded raw data. The decoded raw data includes streaming data and batch data. An incremental computation of features associated with the decoded raw data is performed using at least one dynamic table object. The features are pushed to a feature store using at least one triggered task. Optionally, training of a machine learning model is performed using the features in the feature store.

### PRIORITY CLAIM

This application claims the benefit of priority to U.S. Provisional Patent Application 63/498,916, filed Apr. 28, 2023, and entitled “REAL-TIME FEATURE STORE IN A DATABASE SYSTEM,” which application is incorporated herein by reference in its entirety.

### TECHNICAL FIELD

Embodiments of the disclosure relate generally to databases and, more specifically, to a real-time feature store in a network-based database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and image content. Further, in computing, different database systems may be classified according to the organizational approach of the database. There are many different types of databases, including relational databases, distributed databases, cloud databases, object-oriented databases, and others.

Various users use databases for storing information that may need to be accessed or analyzed. For example, databases can be used in connection with machine learning (ML) and data science workflows, which can be based on features. However, the configuration of a feature store for use in such ML and data science workflows can be challenging and time-consuming.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a diagram illustrating the components of a compute service manager using a feature configuration manager, in accordance with some embodiments of the present disclosure.

FIG. 3 is a diagram illustrating components of an execution platform, in accordance with some embodiments of the present disclosure.

FIG. 4 is a diagram illustrating an example workflow for feature and metric registry and computation using disclosed techniques, in accordance with some embodiments of the present disclosure.

FIG. 5 is a diagram of an example architecture for feature and metric registry, including an attribute store for feature/metric computation, which can be configured by a feature configuration manager, in accordance with some embodiments of the present disclosure.

FIG. 6 is a diagram of a ML processing pipeline using a feature store based on the disclosed techniques, in accordance with some embodiments of the present disclosure.

FIG. 7 is a diagram of streaming data processing which can be used by the disclosed feature configuration manager, in accordance with some embodiments of the present disclosure.

FIG. 8 illustrates example processing channels that can be used for data ingestion during the streaming data processing of FIG. 7, in accordance with some embodiments of the present disclosure.

FIG. 9 is a diagram of a dynamic table, which can be used for computing features by the disclosed feature configuration manager, in accordance with some embodiments of the present disclosure.

FIG. 10 is a diagram illustrating an example data enrichment pipeline using dynamic tables (DTs), in accordance with some embodiments of the present disclosure.

FIG. 11 is a diagram of a view graph of DTs associated with different target lag duration values, in accordance with some embodiments of the present disclosure.

FIG. 12 is a diagram illustrating the use of data manipulation language (DML) commands and time travel queries to compute an updated set of a DT with respect to specific versions of its base relations, in accordance with some embodiments of the present disclosure.

FIG. 13 is a diagram of a DT refresh, in accordance with some embodiments of the present disclosure.

FIG. 14 is a diagram illustrating the determination of changes (or delta (Δ)) to a source table for a DT refresh, in accordance with some embodiments of the present disclosure.

FIG. 15 is a flow diagram illustrating the operations of a database system in performing a method for configuring a triggered task that can be used for computing features by the disclosed feature configuration manager, in accordance with some embodiments of the present disclosure.

FIG. 16 is a flow diagram illustrating the operations of a database system in performing a method for generating features in an attribute store, in accordance with some embodiments of the present disclosure.

FIG. 17 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Aspects of the present disclosure provide techniques for configuring a feature store solution that enables users of a network-based database system (also referred to as customers) to create, store, manage, and use features in connection with data science and ML workflows. The disclosed techniques also support metric stores that enable core batch inferencing (BI) analytics and reporting use cases.

As used herein, the term “feature” indicates an individual measurable property or characteristic of a phenomenon that can be used in ML processing and pattern recognition.

As used herein, the term “view” indicates a named SELECT statement, conceptually similar to a table. In some aspects, a view can be secure, which prevents queries from getting information on the underlying data obliquely.

As used herein, the term “materialized view” (or MV) indicates a data object that returns the result of a defined query, and the data object can be used like a table. Additionally, a materialized view can pre-compute the dataset derived from the query specified in its definition. Since the query output for a materialized view is pre-computed, querying is much faster for a materialized view than it is for a regular view.

As used herein, the term “materialized table” (or MT) indicates data that is the result of a query, which can be periodically updated and queried. The terms “materialized table” and “dynamic table” (DT) are used herein interchangeably. Tasks are powerful, but the conceptual model may limit their usability. Most use cases for tasks can be satisfied with tasks combined with stored procedures, streams, data manipulation language (DML), and transactions. Streams on views can be used to facilitate stateless incremental computations. Some drawbacks associated with tasks (which can be successfully addressed with DTs) include the following: (a) backfill workflows must be implemented and orchestrated manually, and (b) streams cannot cleanly increment stateful operators (GroupBy, outer joins, windows). In some aspects, DTs can be used to improve functionalities provided by tasks and materialized views.

In some aspects, MVs can be used as query accelerators. Simple queries may be sufficient, and only aggregating operations are supported (e.g., no joins and no nested views are supported). Additionally, implementation costs may be insignificant, and less visibility and control may be exposed to users.

In some aspects, DTs can be used to target data engineering use cases. While MVs can support only aggregating operations (e.g., a single GroupBy on a single table), DTs remove query limitations and allow joining and nesting in addition to aggregation. Additional benefits of DTs include providing controls over cost and table refresh operations, automating common operations, including incrementalization and backfill, and providing a comprehensive operational experience. In some embodiments, DTs can be used with the disclosed feature store configuration techniques, namely, for computing features incrementally, which reduces computation latency and feature lag.

The disclosed techniques can be used for streamlining data and feature engineering pipelines using a central repository for managing features or metrics (referred to herein as “feature store,” “metric store,” or “attribute store”) and providing the following functionalities:
(a) having a single source of truth for features and metrics, which results in avoiding redundancy and errors;
(b) enabling collaboration and reuse of features and metrics across different use cases;
(c) facilitating (e.g., automating) feature computation and updates; and
(d) configuring the availability of features, which accelerates experimentation, deployment, and reporting.

In some embodiments, the disclosed techniques use a feature configuration manager (FCM), which can be used to configure feature and metric registry as well as a feature and metric computation pipeline implemented as an attribute store. The disclosed techniques can be used to configure an FCM at a network-based database system so that the FCM configures or performs one or more of the above-recited functionalities.

Real-time features are critical for some machine learning solutions, where features aggregated from recent time windows have a significant influence on the prediction results. The disclosed techniques can be used to compute streaming data and batch data continuously on evolving raw data, refresh the computed feature values in a low-latency serving storage, accumulate computed results into historical feature storage, and backfill feature values from old raw data. In some aspects, the FCM can also provide the following functionalities:
(a) The computed features are maintained fresh. The lag between the time a feature can be computed in theory and the time the computed features are available in serving can be minimized.
(b) Features served in serving storage can be configured with low lookup latency end-to-end (e.g., within 20 ms).
(c) The inconsistency between features served in real-time and features retrieved for ML model training can be detected and sometimes mitigated or removed. The inconsistency can be two-fold:
(c.1) In real time, not all events may be used in aggregation due to possible delayed ingestion. The incompleteness can be applied to historical features as well.
(c.2) In real-time, there can be a lag in feature available time due to scheduling latency and computation latency. Such latency can be applied to historical features.

The disclosed attribute store can be configured with the above functionalities within a network-based database system.

In some aspects, solutions for a feature store can be based on multiple systems, including a streaming engine to compute real-time features, a batch data engine to compute batch features, an orchestrator to trigger those jobs and push the latest features to a serving layer, a backfill job implemented by batch data engine, and a serving layer for low latency feature lookup.

The disclosed techniques can be more advantageous than such solutions due to the following functionalities: reducing engineering complexity with a unified computation engine, providing improved feature freshness (e.g., reducing feature lag), detecting inconsistency between real-time features and offline features, and potentially fixing it by noise simulation, and components can be configured within the same network-based database system so that data governance can be provided.

In comparison to existing feature store solutions, the disclosed techniques are associated with the following advantages:
(a) enabling easy feature/metric specification using a light-weight configuration environment while supporting custom feature transformations and definitions from users' pipelines;
(b) improving feature freshness with continuous, incremental feature updates on new data;
(c) maintaining a historical feature table with consistency between accumulated/incrementally computed features and backfilled features as a single source of truth;
(d) associating features with metadata and time stamps, allowing point-in-time correct retrieval;
(e) linking feature metadata with model metadata for reproducibility of experiments/runs (e.g., a model on a network-based database system can be run by specifying the entity ID instead of listing every feature needed for prediction, which can be a key differentiator in ML workflow);
(f) supporting the serving of fresh features to an external online service;
(g) serving models directly which can use features of the network-based database system;
(h) providing the ability to publish feature sets in a data marketplace; and
(i) providing the ability for users to consume features from the data marketplace to enrich their input data for their ML pipelines.

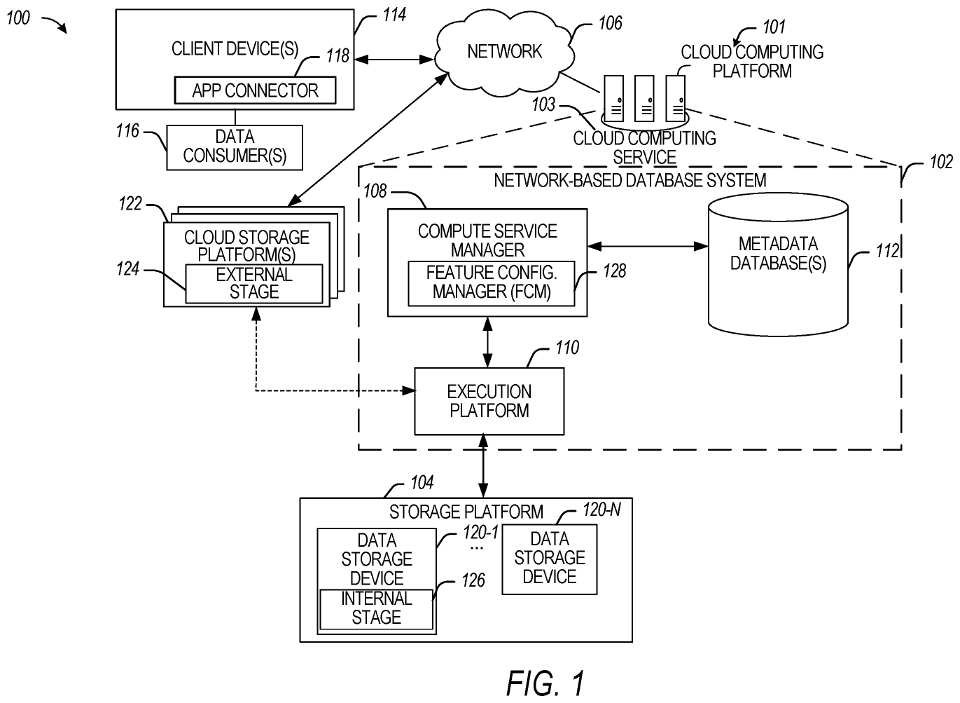

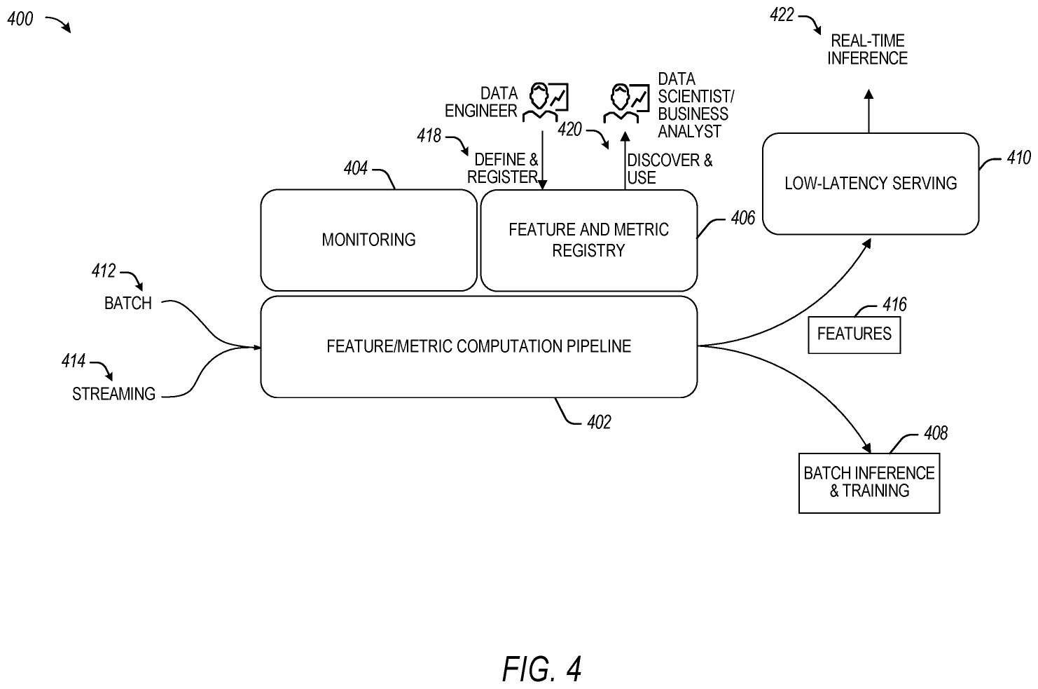

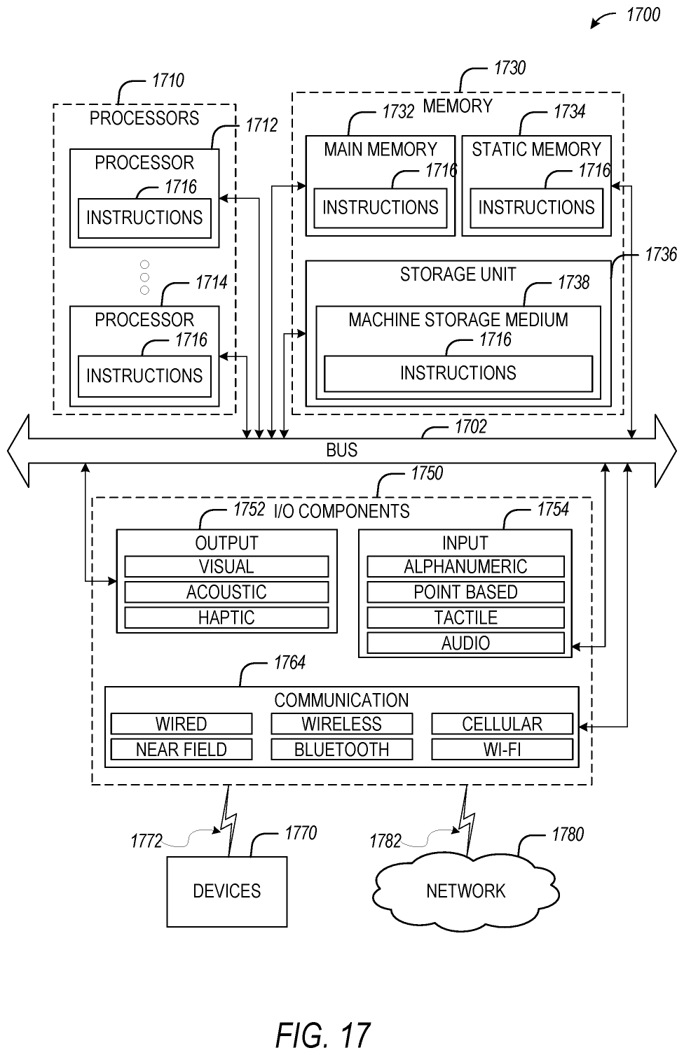

The various embodiments that are described herein are described with reference, where appropriate, to one or more of the various figures. An example computing environment using an FCM for configuring an attribute store is discussed in connection with FIGS. 1-3. Example configuration and functions associated with the FCM are discussed in connection with FIGS. 4-16. A more detailed discussion of example computing devices that may be used in connection with the disclosed techniques is provided in connection with FIG. 17.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104 and 122. The cloud computing platform 101 provides computing resources and storage resources that may be acquired (purchased) or leased (e.g., by users such as data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the attribute store configuration functions described herein). The cloud computing platform 101 may include a three-tier architecture: data storage (e.g., storage platforms 104 and 122), an execution platform 110, and a compute service manager 108 providing cloud services (e.g., functionalities of the feature configuration manager (FCM) 128 to configure an attribute store providing features and metrics which can be used in ML and BI related processing).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed MT-related functions) to multiple client accounts, including an account of the data provider associated with client device 114 and an account of the data consumer 116. In some embodiments, the compute service manager 108 comprises the FCM 128, which can be used in connection with an attribute store, providing features and metrics that can be used in ML and BI-related processing. A more detailed description of the functions provided by the FCM 128 is provided in connection with FIGS. 4-16.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider or another type of user) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed MT-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client devices (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., attribute store-related functions, including providing features and metrics used in ML and BI-related processing) offered by the network-based database system 102 via network 106.

The compute service manager 108 is also coupled to one or more metadata databases 112 that store metadata about various functions and aspects associated with the network-based database system 102 and its users. For example, a metadata database of the one or more metadata databases 112 may include a summary of data stored in remote data storage systems as well as data available from a local cache. Additionally, a metadata database of the one or more metadata databases 112 may include information regarding how data is organized in remote data storage systems (e.g., the storage platform 104) and the local caches. Information stored by a metadata database of the one or more metadata databases 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platforms 104 and 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, the one or more metadata databases 112, the execution platform 110, and the storage platform 104 are shown in FIG. 1 as individual discrete components. However, each of the compute service manager 108, one or more metadata databases 112, execution platform 110, and storage platforms 104 and 122 may be implemented as a distributed system (e.g., distributed across multiple systems/platforms at multiple geographic locations). Additionally, each of the compute service manager 108, one or more metadata databases 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database of the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from and store data to any of the data storage resources in the storage platform 104.

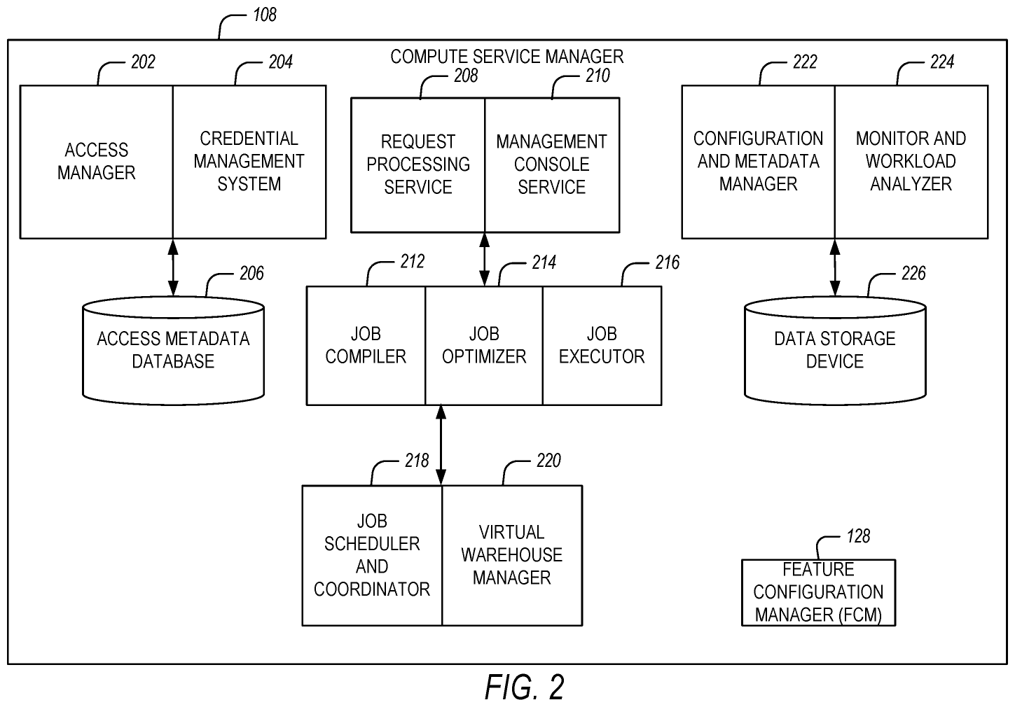

FIG. 2 is a block diagram illustrating components of the compute service manager 108 using an FCM, in accordance with some embodiments of the present disclosure. As shown in FIG. 2, the compute service manager 108 includes an access manager 202 and a credential management system 204 coupled to an access metadata database 206, which is an example of the one or more metadata databases 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs, such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the FCM 128, which can be used in connection with attribute store-related functions, including providing features and metrics used in ML and BI-related processing.

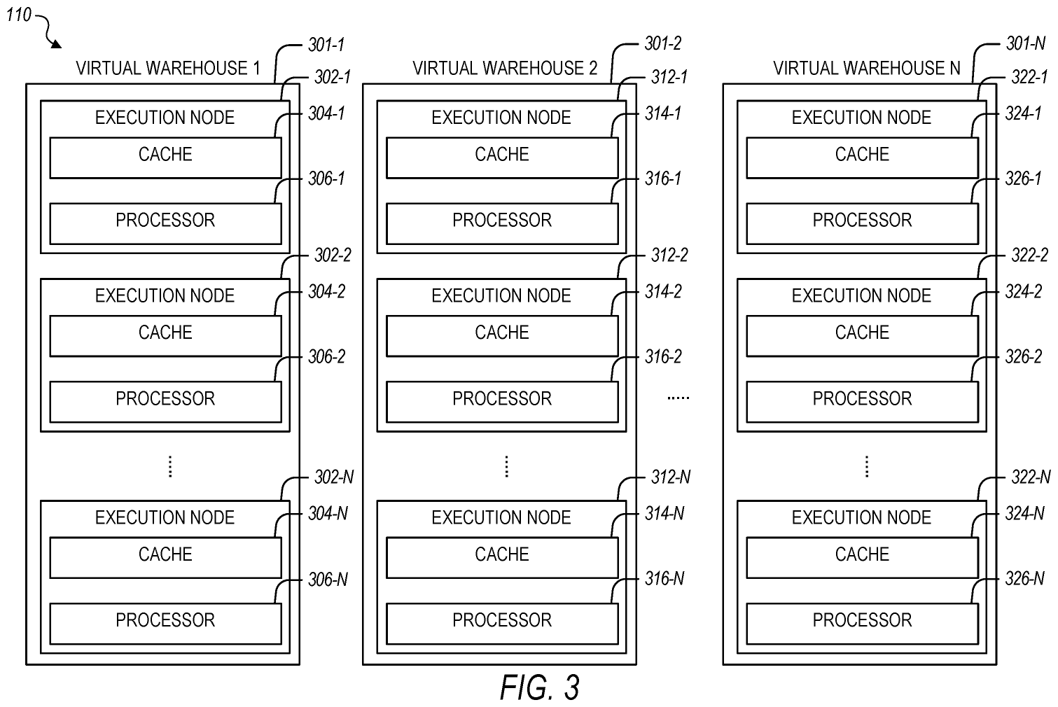

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while another computing system implements virtual warehouses 2 and n at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the storage platform 104, but each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

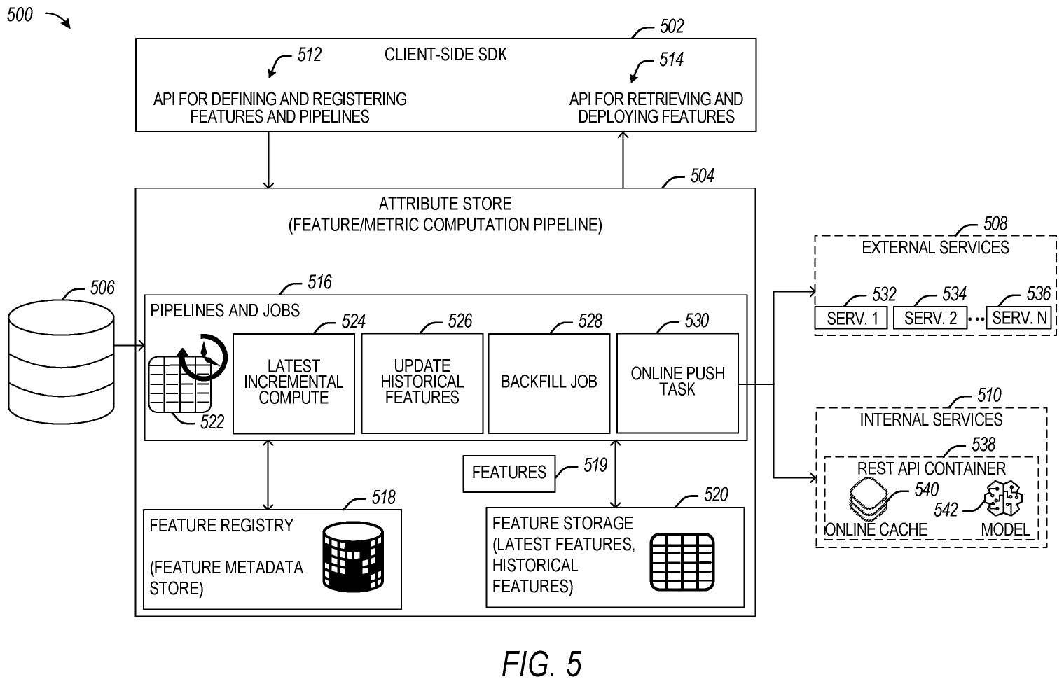

FIG. 4 is a diagram illustrating an example workflow 400 for feature and metric registry and computation using disclosed techniques, in accordance with some embodiments of the present disclosure. Referring to FIG. 4, workflow 400 can be configured by FCM 128 and can include feature/metric computation pipeline 402, monitoring 404, feature and metric registry 406, batch inference and training 408, and low-latency serving 410. Workflow 400 can be configured by the FCM 128, e.g., as discussed in connection with FIG. 5

In some aspects, a user (e.g., a data engineer) can perform the feature and metric registry 406 as part of operation 418, while a different user (e.g., a data scientist or business analyst) can discover and use features at operation 420.

In some aspects, batch data 412 and streaming data 414 are used by the feature/metric computation pipeline 402 to generate features 416. In some aspects, features 416 can be used in batch inference and training 408 or low-latency serving 410 in connection with real-time 422. A more detailed view of an example architecture configured by FCM 128 to perform workflow 400 is illustrated in FIG. 5.

FIG. 5 is a diagram of an example architecture 500 for feature and metric registry, including an attribute store for feature/metric computation, which can be configured by a feature configuration manager, in accordance with some embodiments of the present disclosure. Referring to FIG. 5, architecture 500 includes a client-side software development kit (SDK) 502 and an attribute store 504 with a feature/metric computation pipeline.

In some aspects, the client-side SDK 502 includes an application programming interface (API) 512 for defining and registering features and pipelines and API 514 for retrieving and deploying features. In some aspects, SDK 502 is configured as a thin client-side SDK, which includes APIs 512 and 514 for feature definitions and exposes server-side functions such as suspending/resuming feature pipelines, retrieving historical features, and deploying online services.

In some embodiments, the attribute store 504 is configured as a server-side implementation for handling the resources for feature/metric management. For example, attribute store 504 uses pipelines and jobs 516 to process input data 506 and generate features 519. The attribute store 504 further includes feature store 520 (e.g., to store the latest features (e.g., feature 519) as well as historical features) and a feature registry 518 (e.g., to store feature metadata).

The pipelines and jobs 516 include a processing table 522 (e.g., to receive the input data 506) as well as processing functionalities such as the latest incremental compute processing 524, updating of historical features processing 526, backfill job processing 528, and online push task processing 530.

As used herein, the term “historical features” indicates all available features until the current time. Updating historical features and performing historical features processing 526 can take place at any time there is a new feature computed so that it can be added/appended/modified in the historical features table.

In some aspects, incremental compute processing 524 includes computing features only on new data available since the last processing time.

In some aspects, when a new feature is defined, backfill job processing 528 can be performed and can include calculating that feature on all historical data back in time.

In some aspects, online push task processing 530 includes selecting the newest features and copying such features over to an in-memory cache or database for a low latency lookup.

The features generated by the attribute store 504 (e.g., features in the feature storage 520) can be used by external services 508 (e.g., services 532, 534, . . . 536, which are external to the network-based database system 102) or internal services 510. The internal services 510 are services provided by the network-based database system 102 and can include an online cache 540 or an ML model 542, which can be configured using an API container 538.

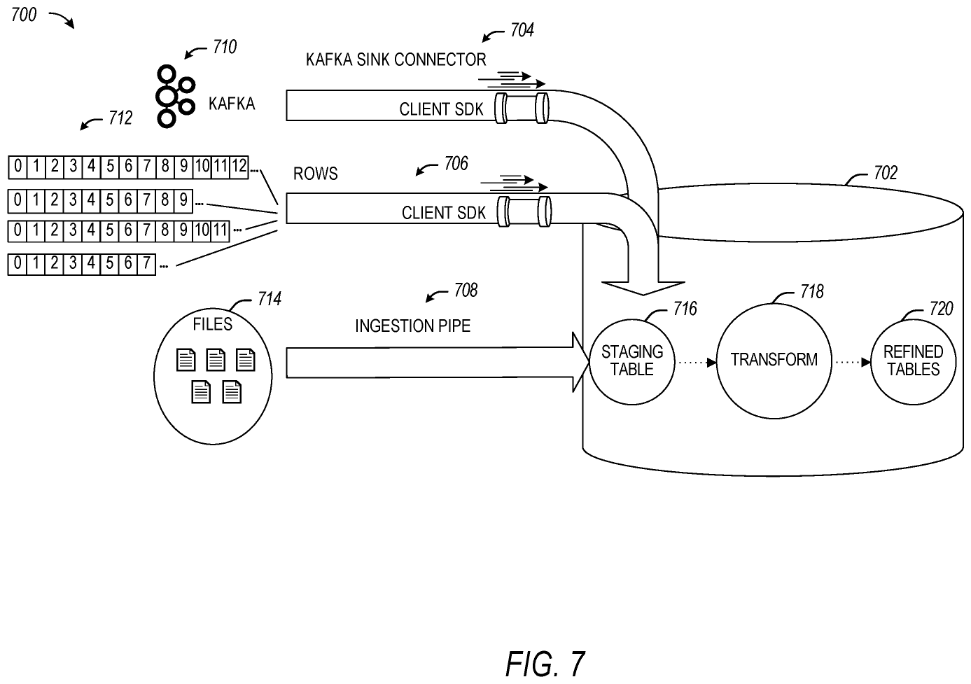

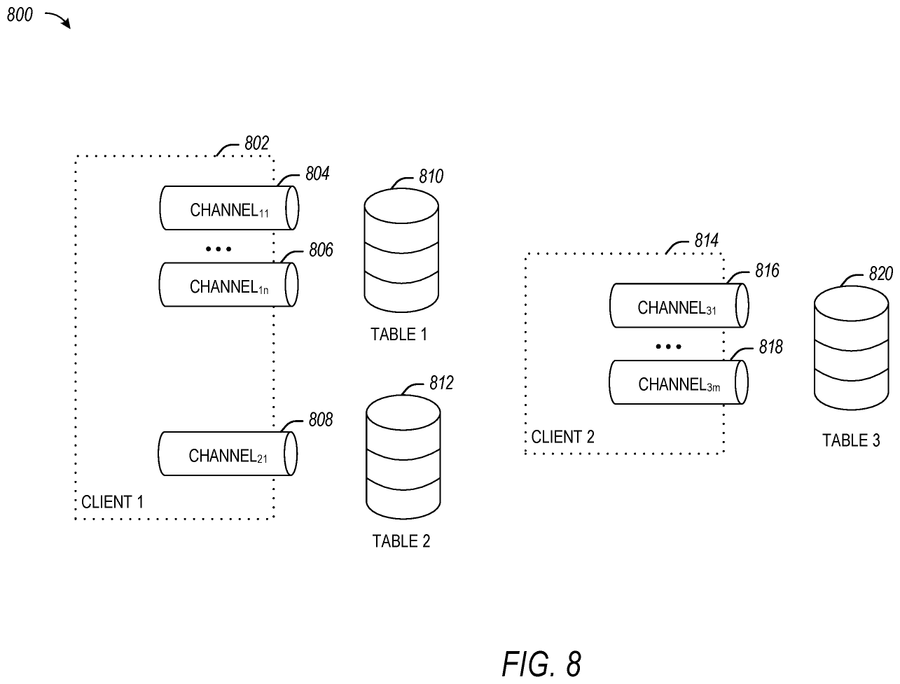

In some embodiments, the attribute store 504 is configured with a unified data processing engine to process streaming data and batch data associated with the input data 506 into the processing table using streaming processing. In some aspects, the streaming processing ensures ingestion latency is within seconds. The streaming processing can include a unified engine, removing feature computation inconsistency between multiple engines and reducing engineering complexity. Additional information regarding the streaming processing is discussed below in connection with FIG. 7 and FIG. 8.

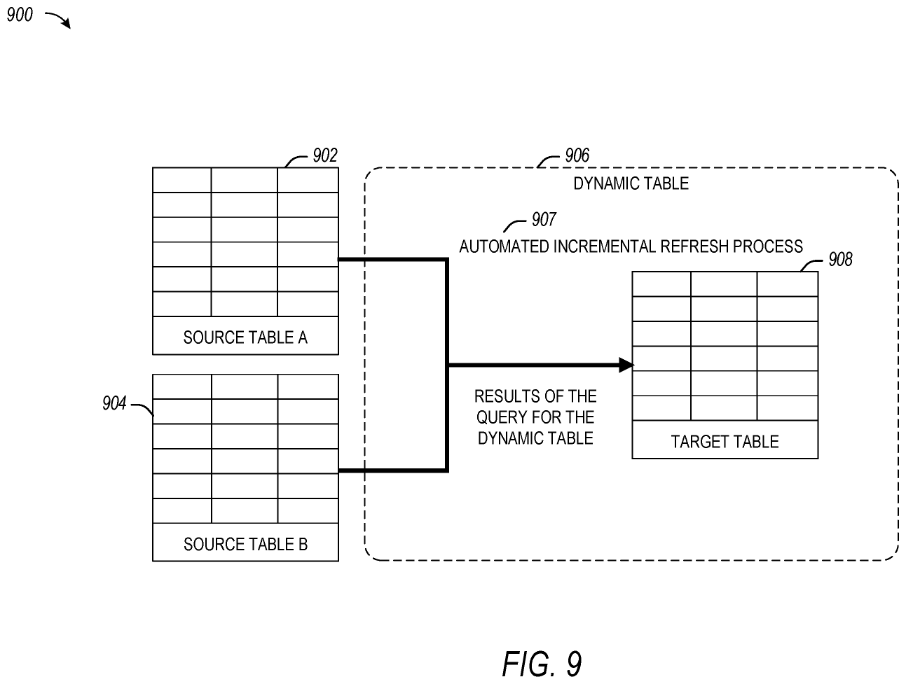

In some embodiments, FCM 128 configures the attribute store 504 with at least one dynamic table for computing features incrementally, which reduces computation latency and feature lag. The declarative fashion of a dynamic table also frees users from engineering a job to periodically compute features. Additional information regarding configurations of dynamic tables that can be used by the FCM 128 is discussed below in connection with FIG. 9-FIG. 14.

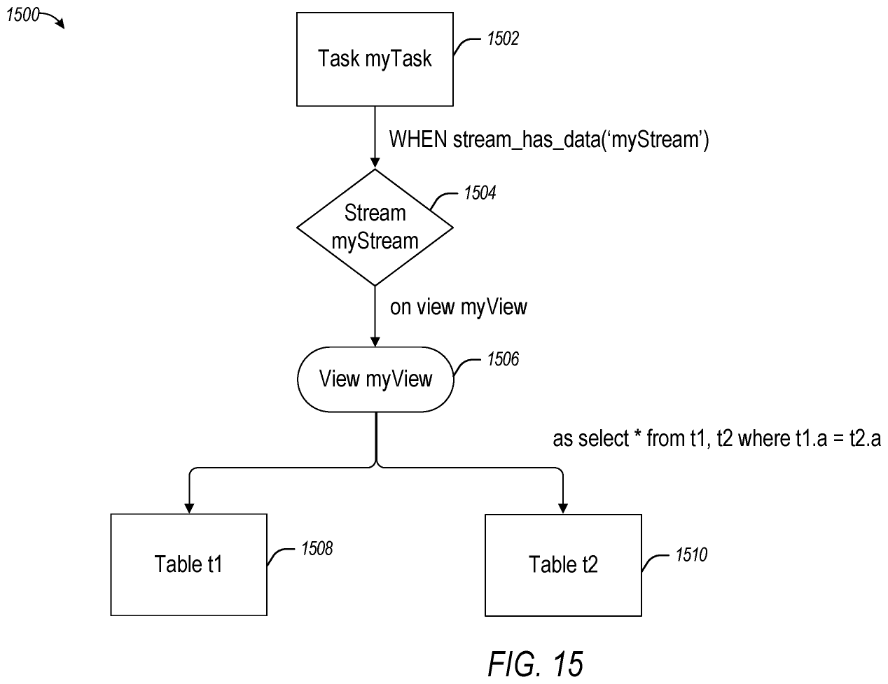

In some embodiments, FCM 128 configures the attribute store 504 with at least one triggered task to further reduce feature lag by removing the scheduling latency introduced by any feature processing jobs for the periodic computation of features. In this regard, the triggered task can be used to push features to a feature store promptly after the features are computed. Additional information regarding configurations of a triggered task that can be used by the FCM 128 is discussed below in connection with FIG. 15.

In some embodiments, FCM 128 configures an online store host so that the processing of architecture 500 can be configured natively within the network-based database system 102. In this regard, each processing step in architecture 500 is trackable to ensure consistency between features computed offline and in real-time by noise simulation, or the drift between features can be monitored and accurately reported to users.

Additional functionalities of the client-side SDK 502 and the attribute store 504 are discussed herein below.

In some embodiments, example user experiences of using the client-side SDK 502 in architecture 500 can include the following:
(a) users define their features using a configuration template or bring ready-to-model feature tables and define feature store mappings;
(b) users call APIs 512 and 514 to browse/enable/suspend/delete/backfill features;
(c) users call API 514 to retrieve historical or latest features for training and batch inference; and
(d) users call API 514 to deploy features to a service for online serving (e.g., one of services 532, . . . , 536). FCM 128 can configure the attribute store 504 for updating and serving point-in-time correct features.

In some embodiments, the client-side SDK 502 includes:
(a) a feature/metric definition specification for specifying entity keys and computation logic;
(b) API 512 for specification of jobs and tasks for incremental feature computation, historical feature table update, and backfilling of features; and
(c) API 514 (e.g., a Feast-like API such as get_historical_features( )) for retrieving point-in-time correct features based on, e.g., a requested entity ID and an event timestamp.

In some aspects, users can prepare their data source by handling joining, filtering, etc., using views or materialized views and running custom feature engineering pipelines.

In some embodiments, the attribute store 504 includes jobs and tasks (e.g., pipelines and jobs 516) that run based on user specifications to compute, update, sync, or serve features.

As used herein, the term “bundle” indicates a schema object with associated hidden schemas, as described herein. A provider user can create a bundle that can be shared with a plurality of consumer users. In some aspects, bundles can be used for code modularity and encapsulation. Additionally, bundles can be implemented as code-only bundles or as code-and-state bundles. Code-only bundles can include packages of code modules such as stored procedures and/or functions. Code-only bundles can be used for packages of geospatial functions, global data sharing stored procedures, etc.

In some aspects, attribute store 504 uses a packaging mechanism (e.g., bundles) to manage resources related to feature and pipeline metadata that handle:
(a) creating and populating a feature table with new incrementally computed features from batch or streaming data sources;
(b) synchronizing new features with a historical feature table;
(c) backfilling the historical feature table when new feature definitions are available; and
(d) serve the latest or historical features in a batch when requested by the client-side API.

In some embodiments, FCM 128 configures the attribute store 504 to use dynamic tables in connection with processing performed by the pipelines and jobs 516. Dynamic tables can be used for such processing as they are optimized for both feature freshness and low cost, especially when computed on frequently updated source data. The incremental computation minimizes processing, and the declarative lag definition removes the need to set up jobs explicitly, further reducing engineering complexity and improving ease of use. Additional details regarding dynamic tables are provided in connection with FIG. 9-FIG. 14.

In some aspects associated with updating historical tables, triggered tasks can be used with streams on dynamic tables to append newly computed feature values into historical tables efficiently. An additional description of triggered tasks is provided in connection with FIG. 15. For raw data that predates the user task or dynamic table, a view backed up by a one-off SQL job can be generated to ensure computation and event latency are consistent with those computed in real-time. By using dynamic tables in data processing, the attribute store 504 can benefit from enhancements and performance increases over time.

In some embodiments, the disclosed techniques can be used for configuring online feature-serving solutions, providing the ability to obtain and cache the latest features. In some aspects, the disclosed techniques can be used to set up external functions for publishing the latest features to an API endpoint. Users may load these features into an online cache solution, and an API can be provided to manage the pushing of features, such as suspend, resume, rollback to a known good timestamp, etc. In some aspects, a container can be provided to serve these features in an in-memory cache. For feature updates, instead of an external function, a user-defined function (UDF) can be used as well.

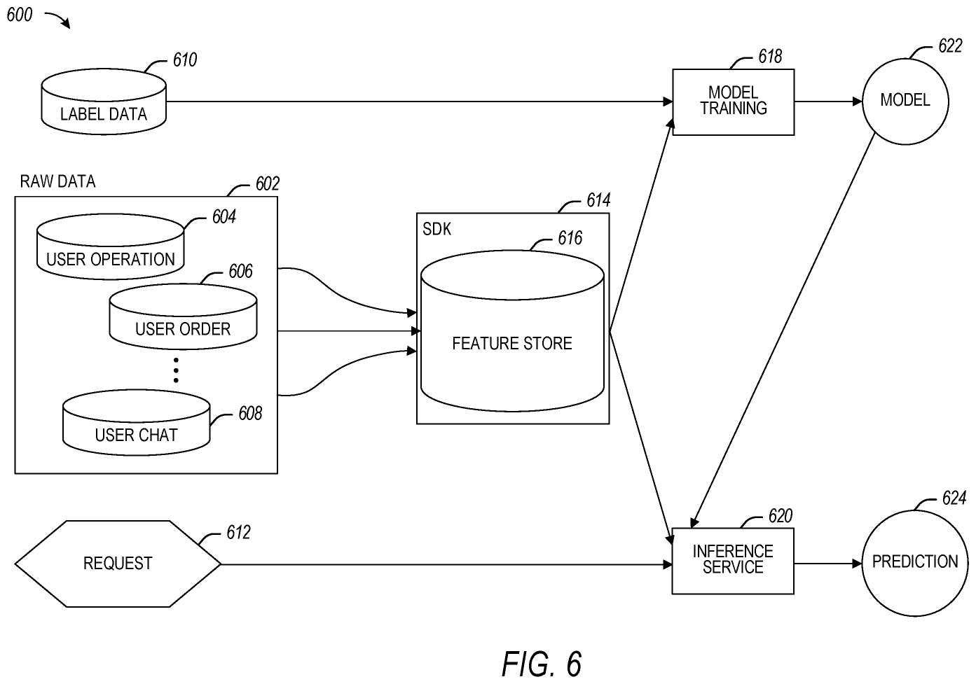

FIG. 6 is a diagram of an ML processing pipeline 600 using a feature store based on the disclosed techniques, in accordance with some embodiments of the present disclosure. Referring to FIG. 6, the ML processing pipeline includes an SDK 614 configured with a feature store 616, which can be the same as the feature store 520 that is part of the attribute store 504 in FIG. 5.

The feature store 616 is configured to store features obtained from raw data 602, including user operations data 604, user orders data 606, user chat data 608, or any other types of raw data. Features from the feature store 616 are used together with label data 610 during model training 618 to generate a trained ML model 622. Additionally, inferencing service 620 uses the trained ML model 622 and features from the feature store 616 to process an inferencing request 612 and generate a prediction 624.

Although FIG. 6 illustrates the feature store 616 as configured/built using SDK 614 (e.g., a Python SDK), the disclosure is not limited in this regard, and features can be declared using SQL or another high-level declarative layer.

FIG. 7 is a diagram of streaming data processing 700, which can be used by the disclosed feature configuration manager, in accordance with some embodiments of the present disclosure. Referring to FIG. 7, streaming data processing can be configured by FCM 128 as part of architecture 500 and the attribute store 504 in connection with receiving incoming data (e.g., raw data 506).

In some embodiments, streaming data processing uses one or more of a Kafka connector 704 (for receiving Kafka-related data 710), a streaming API 706 (for receiving streaming data rows 712), and an ingestion pipe 708 (for receiving file data 714). Incoming data is stored in staging table 716 within database 702. One or more transform operations 718 are applied to the staging table 716 to obtain refined tables 720. The one or more transform operations 718 can include a project/cast operation or an extraction from different data formats.

In some aspects, calling the streaming API 706 prompts low-latency loads of the streaming data rows 712 using ingestion code as part of managed application code. The streaming API 706 writes rows of data to tables, unlike bulk data loads or an ingestion pipe that writes data from staged files (e.g., file data 714). This architecture results in lower load latencies, with corresponding lower costs for loading similar volumes of data, which makes it a powerful tool for handling real-time data streams.

The streaming API 706 can be configured and used to complement the ingestion pipe 708, not replace it. In some embodiments, the streaming API 706 can be used in streaming scenarios where data is streamed via rows (e.g., Apache Kafka topics) rather than written to files. The streaming API 706 can fit into an ingest workflow that includes an existing custom Java application that produces or receives records. In some aspects, the streaming API 706 removes the need to create files to load data into tables and enables the automatic, continuous loading of data streams into staging tables as the data becomes available.

FIG. 8 illustrates example processing channels 800, which can be used for data ingestion during the streaming data processing of FIG. 7, in accordance with some embodiments of the present disclosure. In some embodiments, the streaming API 706 ingests rows via one or more channels. A channel represents a logical named streaming connection to the network-based database system 102 for loading data into a table, where one channel can map to one table; however, multiple channels can point to one table. In some embodiments, FCM 128 can open multiple channels to multiple tables; however, channels cannot be open across accounts. Additionally, the ordering of rows and their corresponding offset tokens are preserved within a channel but not across channels that point to the same table.

For example, and about FIG. 8, processing channels 800 include channels 804, . . . , 806, and 808 configured for client 802, and channels 816, . . . , 818 configured for client 814. Channels 804, . . . , 806 map to table 810, and channel 808 maps to table 812 associated with the account of client 802. Similarly, channels 816, . . . , 818 map to table 820 associated with the account of client 814.

In some aspects, DTs used by the FCM 128 in connection with the disclosed techniques can be configured with the following capabilities:
(a) Incremental refresh: selection, projections (scalar functions), aggregations, and joins (inner, outer, semi, anti). In some aspects, DTs are refreshed incrementally (e.g., when the DTs contain the above-listed operations).
(b) Observability. In some aspects, a user interface (UI) with a simple view graph and account usage views can be used for monitoring.
(c) DT definition evolution can be used to configure a full refresh. In some aspects, DTs can continue functioning when they are replaced. However, updating may be based on a full (non-incremental) refresh. If consuming DTs are broken, updates may pause, and an error may be generated.
(d) Shared data. In some aspects, DTs can read shared tables and views and be shared themselves.
(e) Data transformation tool (e.g., DBT) integration: a custom DBT materialization for users can be used to adopt DTs in data transformation pipelines.

In some aspects, the disclosed techniques can be used to create DTs with the following configurations: minimum lag of 1 second; nesting depth, fan-in, and fan-out of up to 1000 seconds; incremental refreshes for partitioned window functions, subqueries, lateral joins, and recursive queries; integration with other data processing features including streams, row access policies, column masking policies, external tables, directory tables, external functions, user-defined functions (UDFs), and user-defined table functions (UDTFs); support for non-deterministic functions; an interactive UI for monitoring and debugging DT pipelines; incremental DT definition evolution when queries change compatibility; automatic query rewrites into DT scans; stream-like, “append-only” transformations; continuous DML features; merge performance optimizations; and using DTs to implement other features within a Snowflake.

In some aspects, DTs can be defined and orchestrated using data definition language (DDL) commands. For example, a DT can be created using the command CREATE DYNAMIC TABLE <name>[LAG=<duration>]AS<query>. In this regard, a DT can be created using a query on one or more source tables and a lag duration (also referred to as a lag or a lag duration value). The lag duration value indicates a maximum period that a result of a prior refresh of the query can lag behind a current real-time instance (e.g., a current time, which can also be referred to as a current time instance). The lag duration value can be configured as a required parameter.

In some aspects, the DDL command ALTER DYNAMIC TABLE <name>{SUSPEND|RESUME} can be used to suspend or resume a refresh (e.g., to prevent refreshes without deleting DTs entirely).

In some aspects, the DDL command ALTER DYNAMIC TABLE <name> REFRESH can be used for the manual orchestration of data pipelines. In some aspects, the DDL command SHOW DYNAMIC TABLES can be similar to the command SHOW MATERIALIZED VIEWS but with additional columns to show, e.g., lag, source tables, and maintenance plan. In some aspects, when the lag duration is set to infinity, the ALTER command can be used for a manual refresh.

In some aspects, the following DDL command configurations can be used with the disclosed DT-related techniques.

The following syntax may be used with the CREATE command for creating DTs: CREATE [OR REPLACE] DYNAMIC TABLE <name> (<column_list>) [LAG=<duration>] AS<select>. LAG represents a lag duration that the table is allowed to be behind relative to the current time. The term <select> indicates the view definition and may include a selection of both tables, views, projections (scalar functions), aggregates, joins (inner, outer, semi, anti), etc. This definition can be richer than an MV view definition.

In some aspects, if LAG is not specified and the user provides a view definition that is not compatible with the current implementation, then an informative error is generated that will point to a document that details what is allowed/not allowed. Examples of this include a selection on an MV (selects from materialized tables can be allowed, but not classic MVs). Similar to existing MVs, creation requires a CREATE DYNAMIC TABLE privilege on the schema and SELECT privileges on the source tables and sources.

The following configurations may be used with the ALTER command. The command can be configured as ALTER DYNAMIC TABLE <name> {SUSPEND|RESUME}. This command allows the user to stop the DT from updating itself via its refresh strategy. A DT can remain suspended until a RESUME is executed.

In some aspects, the command ALTER DYNAMIC TABLE <name> set LAG=<duration> can be used to change the lag of the materialized table. The subsequent scheduled execution of the refresh can reflect the updated lag.

In some aspects, the command ALTER DYNAMIC TABLE <name> REFRESH [AT(<at_spec>)] can be used to initiate an immediate refresh of the DT. This command may be used with data engineering use cases that may require more direct control over refreshes. For example, it may be common for imperative data pipelines to spend a significant amount of time in an inconsistent state, with new data only partially loaded. Authors of such pipelines would not want a refresh to occur during these inconsistent periods, and they may disable automatic refresh (LAG=‘infinity’) and invoke REFRESH when they know the database is in a consistent state.

In some aspects, the optional AT clause can be used to allow users to control the transactional time from which the DT's source data is read. Using this, they can ensure that multiple manually-orchestrated DTs are aligned correctly, even during backfills.

In some aspects, commands ALTER DYNAMIC TABLE <name> set REFRESH MODE={INCREMENTAL|FULL|AUTO} and ALTER DYNAMIC TABLE <name> unset REFRESH_MODE can be used to change the refresh mode on the DT. The change can be reflected in the next reprocessing of the DT. Unset sets the refresh mode back to the system default. The INCREMENTAL value may be used to maintain the DT by processing changes to the source(s) incrementally. The FULL value may be used to perform a complete refresh of the DT (i.e., an entire re-computation). The AUTO value indicates that the network-based database system can determine whether to perform an incremental or full refresh, any may alternate between the two depending on upstream changes and the view definition.

In some aspects, the DROP DYNAMIC TABLE <name> command can be configured.

In some aspects, SHOW DYNAMIC TABLES [LIKE ‘<pattern>’] [IN {ACCOUNT|DATABASE [<db_name>] | [SCHEMA] [<schema_name>]}] command can be configured. The existing syntax can be kept, but the following columns can be added to the existing output:
(a) lag: the user-defined lag duration specified during creation. This configuration can be static, unlike the existing columns.
(b) source_names: a column that has the fully qualified names of the sources used in the DT as a list, ex. [“db”. “schema”. “table”]. For a longer term, source_database_name, source_schema_name, and source_table_name can be deprecated in favor of this new column as these will be null for DTs.

In some aspects, the following variants of the EXPLAIN command may be used in connection with the disclosed DT-related functionalities (e.g., to obtain details of an operation on a DT):
(a) EXPLAIN CREATE DYNAMIC TABLE <mv>LAG=<duration> AS<query> can be used to show the refresh plan before creating a DT.
(b) EXPLAIN ALTER DYNAMIC TABLE <mv> REFRESH [AT (<at_spec>)] can be used to show the refresh plan for an extant DT.
(c) EXPLAIN SELECT <select> FROM <mv> can be used to show the version and plan used to resolve the DT.

In some aspects, a stream on a DT can be created, similarly to a stream on a view.

FIG. 9 is a diagram 900 of a dynamic table, which can be used for computing features by the disclosed feature configuration manager, in accordance with some embodiments of the present disclosure. Referring to FIG. 9, DT 906 uses an automated incremental refresh process 907 to store the results of a query applied to source tables 902 and 904 into a target table 908 (which is part of DT 906).

In some aspects, DTs allow the use of SQL statements to define the result of at least one data pipeline declaratively. DTs can be configured to automatically refresh as the data changes, only operating on new changes since the last refresh. Scheduling and orchestration of the automatic refreshes can be managed transparently within the network-based database system 102. In short, DTs can be used to simplify the experience of creating and managing data pipelines and give engineering teams the ability to build production-grade data pipelines with confidence. Previously, a data engineer could use streams and tasks objects along with manually managing the database objects (tables, streams, tasks, SQL DML code) to build a data pipeline. However, DTs can be used (e.g., by the FCM 128) to configure data pipelines more easily.

In some aspects, through the use of DTs for data pipelines, data transformations are defined using SQL statements, the results of which are automatically materialized and refreshed as input data changes (e.g., as illustrated in FIG. 9). DTs support incremental materialization so that users can expect better performance and lower cost compared to DIY data pipelines, and tables can be chained together to create a directed acyclic graph (DAG) pipeline of 100s of tables. In some aspects, DTs can be configured with the following functionalities:
(a) Declarative data pipelines: Users can use SQL CTAS (create-table-as-select) queries to define how the data pipeline output should look (there is no need to set up any jobs or tasks to do the transformation). A DT can select from regular tables or other DTs, forming a DAG (no need to manage a collection of streams and tasks as DTs can be used to manage the scheduling and orchestration).
(b) SQL-first: Any SQL query expression can be used to define transformations, similar to the way users define SQL views. In this regard, current pipeline logic can be lifted and shifted because users can aggregate data, join across multiple tables, and use other SQL constructs.
(c) Automatic (and intelligent) incremental refreshes. DTs can refresh only what is changed, even for complex queries, automatically. Processing only new/changing data can save costs significantly, especially as data volume increases. There is no need to track scheduling for dependent tables, as DTs can intelligently fall back to full refresh in cases when it is cheaper (or more sensible). DTs will also intelligently skip any refreshes in cases where there is no new data to process or if dependent tables are still refreshing without any user intervention.
(d) User-defined freshness. Controlled by a target lag for each table, DTs are allowed to lag in real-time, with queries returning results up to a user-specific limit for the sake of reduced cost and improved performance. In this regard, DTs can be used to configure the delivery of data to users as fresh as 1 minute.
(e) Snapshot isolation. This functionality can be configured across the entire user account at the network-based database system. For example, DTs in a DAG are refreshed consistently from aligned snapshots. A DT will never return inconsistent data as its content is always a result that the defining query would have returned at some point in the past.

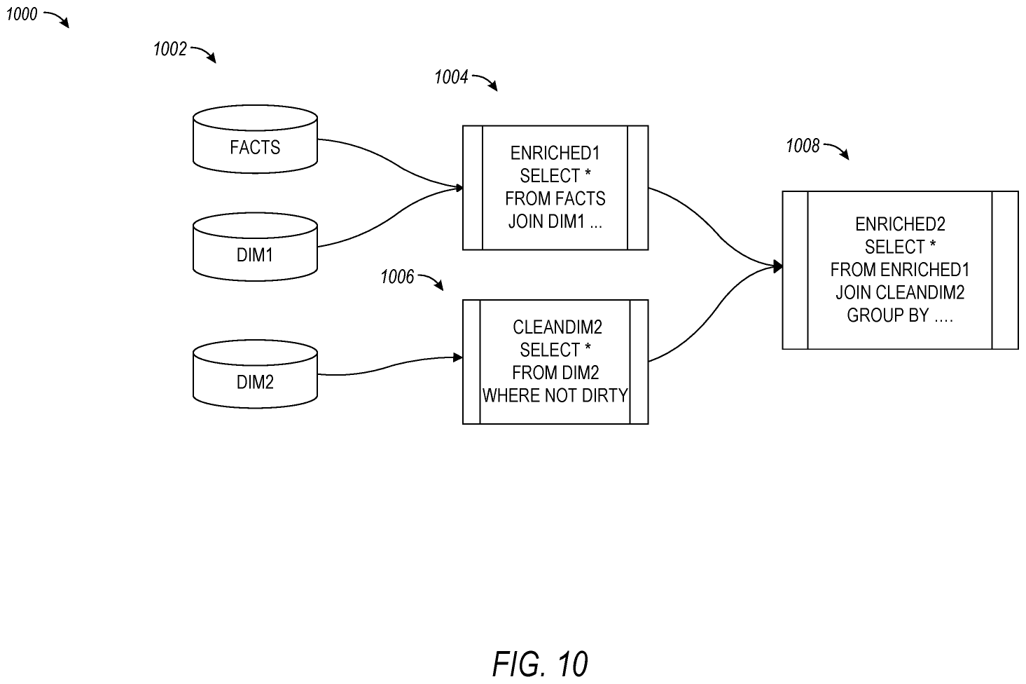

FIG. 10 is diagram 1000 illustrating an example data enrichment pipeline using DTs, in accordance with some embodiments of the present disclosure.

In some aspects, DT definitions are rendered into a dependency graph, where each node in the graph is a DT query, edges indicate that one DT depends on the results of another, leaf nodes are DTs on source tables, and DDLs (e.g., DDL commands) can be used to log graph changes to a metadata database (e.g., the one or more metadata databases 112), and an in-memory representation of the graph can be rendered.

Referring to FIG. 10, DT Enriched1 1004 is created using a subset of the source tables 1002, namely, source tables Facts and Dim1. DT CleanDim2 1006 is created using source table Dim2 of source tables 1002. DT Enriched2 1008 is created from DTs Enriched1 and CleanDim2. In this regard, the following processing sequence can be used: (a) a DT is created using other DTs; (b) the DTs (e.g., the DTs 1004-1008 in FIG. 10) form an acyclic dependency graph (e.g., a directed acyclic graph or DAG); a query in the final DT (e.g., DT Enriched2 1008) is parsed to obtain two or more dependent DTs (e.g., DTs Enriched1 1004 and CleanDim2 1006); and DT refreshes can be scheduled based on the configurations of each DT.

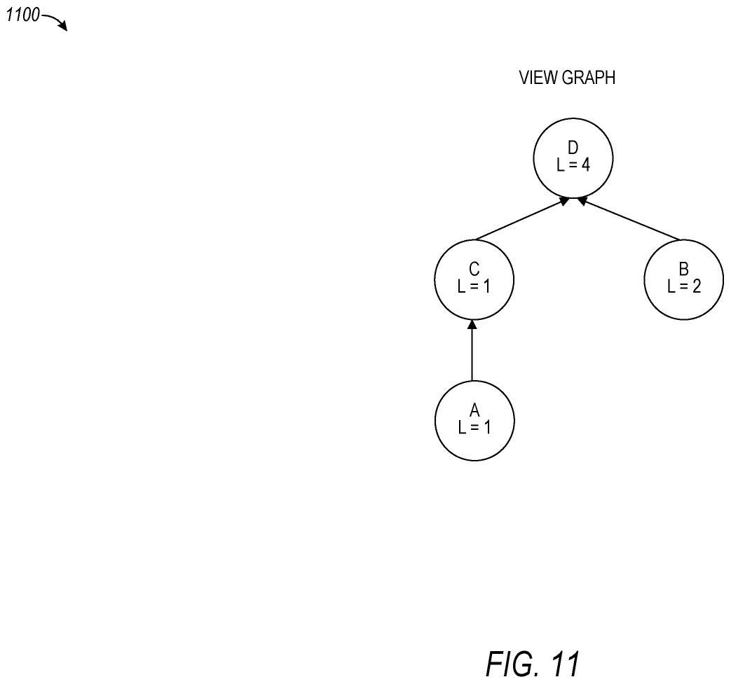

FIG. 11 is a diagram of a view graph 1100 of DTs associated with different target lag duration values, in accordance with some embodiments of the present disclosure. Referring to FIG. 11, view graph 1100 (also referred to as dependency graph 1100) is associated with a dependency relationship between DTs with different target lag duration values (indicated as L). For example, DT A (with a target lag duration value of L=1) feeds to DT C (with L=1), and DT D (with L=4) uses data from DT C (L=1) and DT B (L=2).

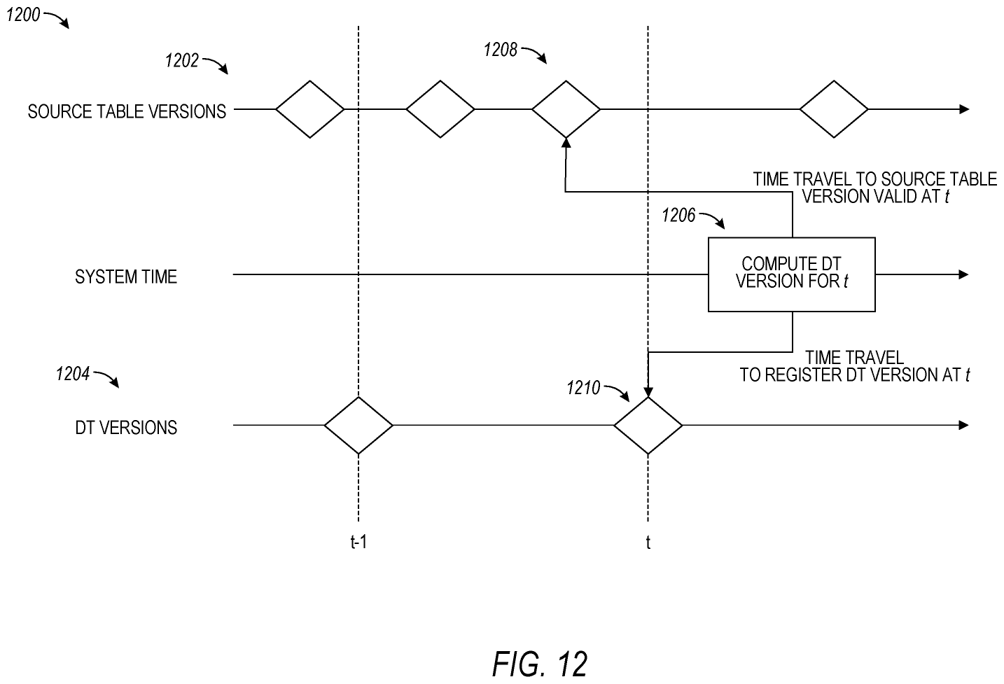

FIG. 12 is diagram 1200 illustrating the use of data manipulation language (DML) commands and time travel queries to compute an updated set of a DT with respect to specific versions of its base relations, in accordance with some embodiments of the present disclosure.

In some aspects, the table versions 1204 of DTs may be aligned with the source table versions 1202 of their corresponding source tables. Using time travel queries (e.g., query 1206), the update set of a DT 1210 may be computed concerning specific versions (e.g., source table 1208) of its base relations (e.g., as illustrated in FIG. 12). The new DT version that results from merging the update set in alignment may be registered with the versions of its base relations. Hence, capabilities for the DMLs that update DTs may also be configured. The following describes how to register table versions for DTs and how to look up their versions when they are queried for a specific time.

In some aspects, DML commands that create table versions at a specific time in a DT's source tables' time domain can be configured. The base version time of a new version can be assumed to be after all preceding DT table version base times. Additionally, reads can resolve table versions in this time domain.

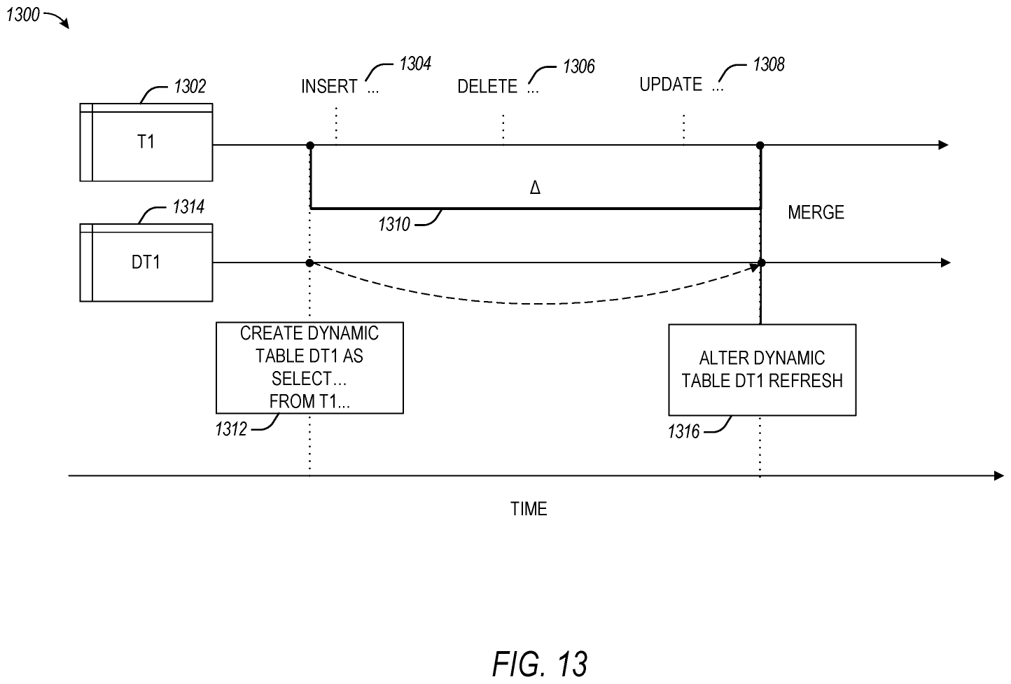

FIG. 13 is diagram 1300 of a dynamic table (DT) refresh, in accordance with some embodiments of the present disclosure. Referring to FIG. 13, at operation 1312, a dynamic table DT1 1314 is created as a SELECT from source table T1 1302. A delta set 1310 can be computed for source table 1302, which can include data changes based on an INSERT operation 1304, a DELETE operation 1306, and an UPDATE operation 1308 applied to source table 1302. A REFRESH operation 1316 can be performed on DT1 1314 by merging the delta set 1310 with DT1 1314.

In some aspects, an incremental refresh of DTs can be configured using configurations and techniques discussed herein. An incremental refresh can be a more optimal function in place of computing the state of a DT every time a refresh is needed. During an incremental refresh, data is considered from the last time query results are computed, the difference between the query results and a new value is determined, and the determined change (or difference) is applied on top of the previous result.

The disclosed incremental refresh configurations can be used to handle several interdependent scenarios, which can make it challenging to partition into independent pieces. The scenarios are:
(a) Nested DTs: a DT queries another DT. Changes to one must be incrementally propagated to the other.
(b) Composite DTs: a single DT contains a sufficiently complex query that needs to be split into two or more DTs containing an intermediate state. A simple example of this scenario is COUNT (DISTINCT*).
(c) Query Facades: when querying a DT, the query plan may need to apply additional operations atop the intermediate state to compute the correct result. An example of this is AVG ( ) which can be stored as SUM ( ) and COUNT ( ) separately and then produced as the quotient.

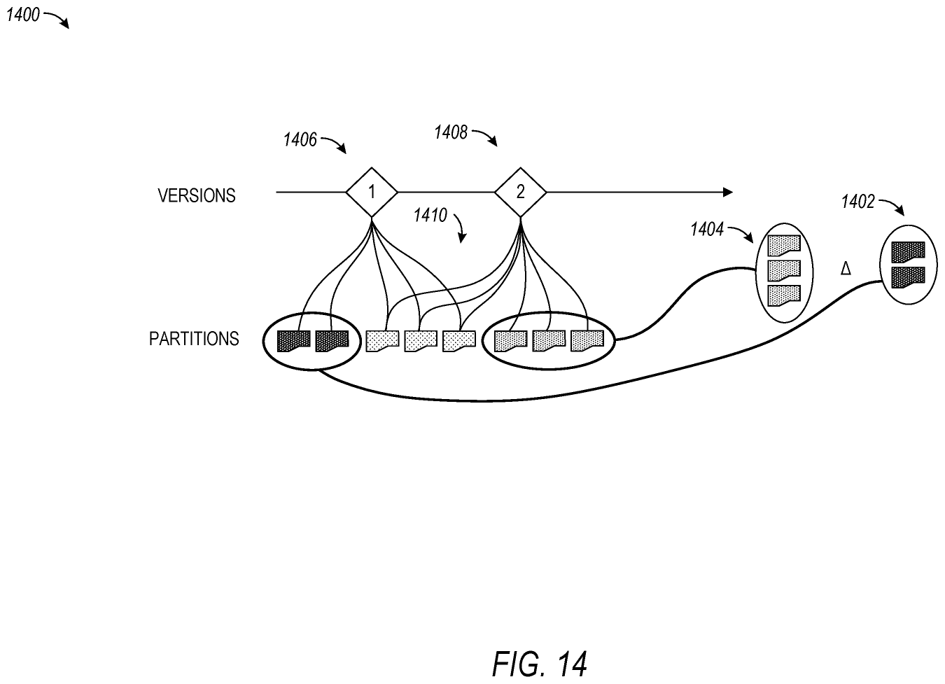

FIG. 14 is a diagram 1400 illustrating the determination of changes (or delta (Δ) or delta set) to a source table for a DT refresh, in accordance with some embodiments of the present disclosure. Referring to FIG. 14, a source table can be associated with versions 1406 and 1408 (also referenced as 1 and 2 in FIG. 14). To determine the delta set, the deleted rows 1404 are determined, and the new (added) rows 1402 are determined. The common rows 1410 can be ignored for purposes of delta set determination. The delta set is the combination of the deleted rows 1404 and the new rows 1402. In some aspects, the DT lifecycle can be modeled as the following four phases: creation, scheduling, refresh, and query.

In some aspects, triggered tasks are a way to automatically run a task that depends on a stream when the stream has new data added to it (its underlying table(s) change). In some embodiments, this functionality is accomplished by running the task every minute and polling the stream to check for data changes, which can be inefficient and too slow for many users. As used herein, the term “schedule-based task” indicates the current task offering; a task that runs on a user-specified schedule such as “every 10 minutes” or “at noon on the 1st day of every month”. As used herein, the term “triggered task” indicates a task that runs only when an object that it depends on, such as a stream, has a corresponding event that occurs, such as an insert/update/delete.

The following are examples of triggering events for a triggered task. In some aspects, events that would cause a task pipeline to kick off when they happen in the system include:
(a) stream_has_data (‘stream_name’): new data lands in a stream due to DML on its underlying table(s). Regular tables are the vast majority of use cases, followed by external tables, views, and finally, shared tables. In some aspects, AND/OR conditions can be included in the WHEN clause (trigger if BOTH these streams have data, or if EITHER of these streams has data, etc.).
(b) Task graph (pipeline) completing to allow other pipelines to be kicked off without creating a predecessor/successor relationship between them.

FIG. 15 is a flow diagram illustrating the operations of a database system in performing method 1500 for configuring a triggered task, which can be used for computing features by the disclosed feature configuration manager, in accordance with some embodiments of the present disclosure. Method 1500 may be embodied in computer-readable instructions for execution by one or more hardware components (e.g., one or more processors) such that the operations of method 1600 may be performed by components of network-based database system 102, such as components of the compute service manager 108 (e.g., the FCM 128) and/or the execution platform 110 (which components may be implemented as machine 1700 of FIG. 17). Accordingly, method 1500 is described below, by way of example with reference thereto. However, it shall be appreciated that method 1500 may be deployed on various other hardware configurations and is not intended to be limited to deployment within the network-based database system 102.

In some aspects, objects that a triggered task is dependent on, such as the stream or its underlying table, may be altered or dropped after the trigger dependencies have already been set up. Streams on views can further complicate this since views can have multiple table dependencies of their own, which can change, and the view definition itself may be altered. This may not be an issue for polling the WHEN clause because everything is resolved when the task runs. For triggered tasks, however, any modifications that change the set of source table dependencies will cause the triggered task not to work anymore, as the stored dependencies will be for the old set of objects. When DML happens against the new object that's the new base of the stream, no triggered task will be identified as needing to run.

The example method 1500 includes, at operation 1502, a “myTask” triggered task is configured. At operation 1504, a determination is made if the “myStream” stream has data. If it has data, at operation 1506, stream on the “my View” view is configured using a select statement, with the result being pushed to tables 1508 and 1510 for further processing.

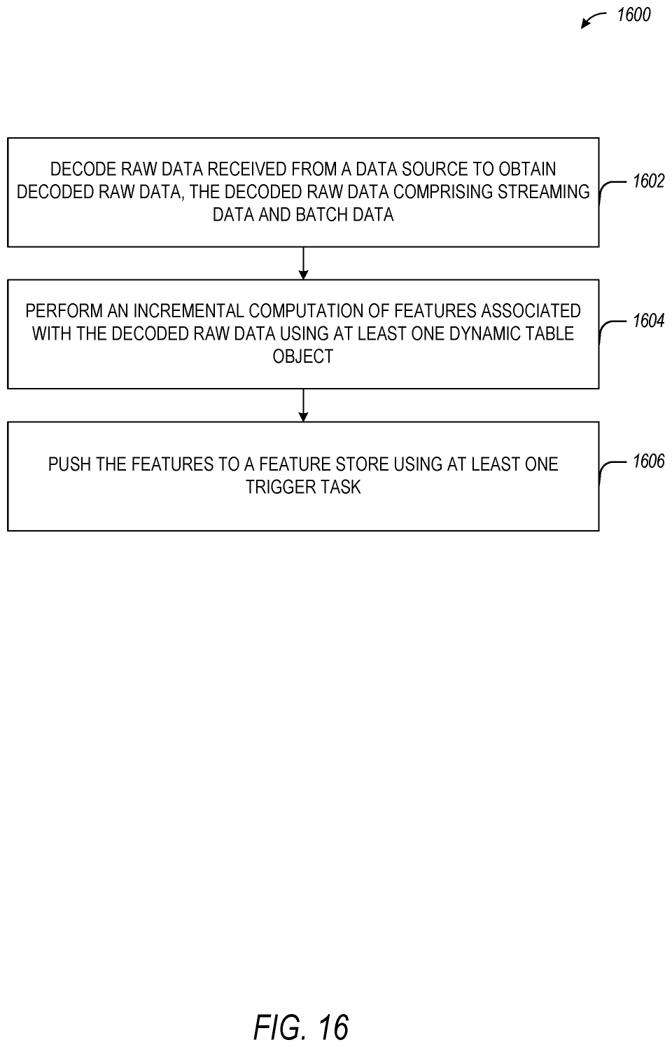

FIG. 16 is a flow diagram illustrating the operations of a database system in performing method 1600 for generating features in an attribute store, in accordance with some embodiments of the present disclosure. Method 1600 may be embodied in computer-readable instructions for execution by one or more hardware components (e.g., one or more processors) such that the operations of method 1600 may be performed by components of network-based database system 102, such as components of the compute service manager 108 (e.g., the FCM 128) and/or the execution platform 110 (which components may be implemented as machine 1700 of FIG. 17). Accordingly, method 1600 is described below, by way of example with reference thereto. However, it shall be appreciated that method 1600 may be deployed on various other hardware configurations and is not intended to be limited to deployment within the network-based database system 102.

At operation 1602, raw data received from a data source is decoded to obtain decoded raw data. The decoded raw data includes streaming data and batch data.

At operation 1604, an incremental computation of features associated with the decoded raw data is performed using at least one dynamic table object.

At operation 1606, the features are pushed to a feature store using at least one triggered task.

FIG. 17 illustrates a diagrammatic representation of machine 1700 in the form of a computer system within which a set of instructions may be executed for causing machine 1700 to perform any one or more of the methodologies discussed herein, according to an example embodiment. Specifically, FIG. 17 shows a diagrammatic representation of the machine 1700 in the example form of a computer system, within which instructions 1716 (e.g., software, a program, an application, an applet, an app, or other executable code) for causing the machine 1700 to perform any one or more of the methodologies discussed herein may be executed. For example, instructions 1716 may cause machine 1700 to execute any one or more operations of method 1600 (or any other technique discussed herein, for example, in connection with FIG. 4-FIG. 16). As another example, instructions 1716 may cause machine 1700 to implement one or more portions of the functionalities discussed herein. In this way, instructions 1716 may transform a general, non-programmed machine into a particular machine 1700 (e.g., the compute service manager 108 or a node in the execution platform 110) that is specially configured to carry out any one of the described and illustrated functions in the manner described herein. In yet another embodiment, instructions 1716 may configure the compute service manager 108 and/or a node in the execution platform 110 to carry out any one of the described and illustrated functions in the manner described herein.

In alternative embodiments, machine 1700 operates as a standalone device or may be coupled (e.g., networked) to other machines. In a networked deployment, machine 1700 may operate in the capacity of a server machine or a client machine in a server-client network environment, or as a peer machine in a peer-to-peer (or distributed) network environment. Machine 1700 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1716, sequentially or otherwise, that specify actions to be taken by the machine 1700. Further, while only a single machine 1700 is illustrated, the term “machine” shall also be taken to include a collection of machines 1700 that individually or jointly execute the instructions 1716 to perform any one or more of the methodologies discussed herein.

Machine 1700 includes processors 1710, memory 1730, and input/output (I/O) components 1750 configured to communicate with each other, such as via a bus 1702. In some example embodiments, the processors 1710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1712 and a processor 1714 that may execute the instructions 1716. The term “processor” is intended to include multi-core processors 1710 that may comprise two or more independent processors (sometimes referred to as “cores”) that may execute instructions 1716 contemporaneously. Although FIG. 17 shows multiple processors 1710, the machine 1700 may include a single processor with a single core, a single processor with multiple cores (e.g., a multi-core processor), multiple processors with a single core, multiple processors with multiple cores, or any combination thereof.

The memory 1730 may include a main memory 1732, a static memory 1734, and a storage unit 1736, all accessible to the processors 1710, such as via the bus 1702. The main memory 1732, the static memory 1734, and the storage unit 1736 store the instructions 1716, embodying any one or more of the methodologies or functions described herein. The instructions 1716 may also reside, wholly or partially, within the main memory 1732, within the static memory 1734, within machine storage medium 1738 of the storage unit 1736, within at least one of the processors 1710 (e.g., within the processor's cache memory), or any suitable combination thereof, during execution thereof by the machine 1700.

The I/O components 1750 include components to receive input, provide output, produce output, transmit information, exchange information, capture measurements, and so on. The specific I/O components 1750 that are included in a particular machine 1700 will depend on the type of machine. For example, portable machines such as mobile phones will likely include a touch input device or other such input mechanisms, while a headless server machine will likely not include such a touch input device. It will be appreciated that the I/O components 1750 may include many other components that are not shown in FIG. 17. The I/O components 1750 are grouped according to functionality merely to simplify the following discussion, and the grouping is in no way limiting. In various example embodiments, the I/O components 1750 may include output components 1752 and input components 1754. The output components 1752 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1750 may include communication components 1764 operable to couple the machine 1700 to a network 1780 or devices 1770 via a coupling 1782 and a coupling 1772, respectively. For example, communication components 1764 may include a network interface component or another suitable device to interface with network 1780. In further examples, communication components 1764 may include wired communication components, wireless communication components, cellular communication components, and other communication components to provide communication via other modalities. The device 1770 may be another machine or any of a wide variety of peripheral devices (e.g., a peripheral device coupled via a universal serial bus (USB)). For example, as noted above, machine 1700 may correspond to any one of the compute service manager 108 or the execution platform 110, and device 1770 may include the client device 114 or any other computing device described herein as being in communication with the network-based database system 102 or the storage platform 104.

The various memories (e.g., 1730, 1732, 1734, and/or memory of the processor(s) 1710 and/or the storage unit 1736) may store one or more sets of instructions 1716 and data structures (e.g., software) embodying or utilized by any one or more of the methodologies or functions described herein. The instructions 1716, when executed by the processor(s) 1710, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1780 or a portion of network 1780 may include a wireless or cellular network, and coupling 1782 may be a Code Division Multiple Access (CDMA) connection, a Global System for Mobile Communications (GSM) connection, or another cellular or wireless coupling. In this example, the coupling 1782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1716 may be transmitted or received over network 1780 using a transmission medium via a network interface device (e.g., a network interface component included in the communication components 1764) and utilizing any one of several well-known transfer protocols (e.g., hypertext transfer protocol (HTTP)). Similarly, instructions 1716 may be transmitted or received using a transmission medium via coupling 1772 (e.g., a peer-to-peer coupling) to device 1770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1716 for execution by the machine 1700 and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising at least one hardware processor; and at least one memory storing instructions that cause the at least one hardware processor to perform operations comprising decoding raw data received at a database system from a data source to obtain decoded raw data, the decoded raw data comprising streaming data and batch data; performing an incremental computation of features associated with the decoded raw data using an at least one dynamic table object; and pushing the features to a feature store using at least one triggered task.

In Example 2, the subject matter of Example 1 includes the operations further comprising decoding the streaming data as a plurality of streaming data rows received from the data source via a streaming application programming interface (API).

In Example 3, the subject matter of Example 2 includes the operations further comprising ingesting the plurality of streaming data rows in a staging table of the database system using ingestion code of the streaming API; and ingesting the batch data in the staging table from data files, the batch data received via an ingestion pipe of the database system.

In Example 4, the subject matter of Example 3 includes the operations further comprising configuring the streaming API as an API executing at an account of a user of the database system.

In Example 5, the subject matter of Example 4 includes the operations further comprising detecting availability of the streaming data rows at the account of the user of the database system using the streaming API.

In Example 6, the subject matter of Examples 3-5 includes the operations further comprising ingesting the plurality of streaming data rows in the staging table using a plurality of communication channels configured as logically named streaming connections of the database system.

In Example 7, the subject matter of Examples 3-6 includes the operations further comprising applying one or more transform operations to the staging table to generate the at least one dynamic table object.

In Example 8, the subject matter of Example 7 includes the operations further comprising: detecting using the at least one dynamic table object, new streaming data in one or more source tables storing the plurality of streaming data rows.

In Example 9, the subject matter of Example 8 includes the operations further comprising performing a refresh of the at least one dynamic table object based on the detection of the new streaming data.

In Example 10, the subject matter of Examples 1-9 includes the operations further comprising performing training of a machine learning model using the features in the feature store to generate a trained machine learning model, and processing an inferencing request using the features and the trained machine learning model to generate a prediction associated with the inferencing request.

Example 11 is a method comprising decoding, by at least one hardware processor, raw data received at a database system from a data source to obtain decoded raw data, the decoded raw data comprising streaming data and batch data; performing an incremental computation of features associated with the decoded raw data using an at least one dynamic table object; and pushing the features to a feature store using at least one triggered task.

In Example 12, the subject matter of Example 11 includes decoding the streaming data as a plurality of streaming data rows received from the data source via a streaming application programming interface (API).

In Example 13, the subject matter of Example 12 includes ingesting the plurality of streaming data rows in a staging table of the database system using ingestion code of the streaming API; and ingesting the batch data in the staging table from data files, the batch data received via an ingestion pipe of the database system.

In Example 14, the subject matter of Example 13 includes configuring the streaming API as an API executing at an account of a user of the database system.

In Example 15, the subject matter of Example 14 includes detecting availability of the streaming data rows at the account of the user of the database system using the streaming API.

In Example 16, the subject matter of Examples 13-15 includes ingesting the plurality of streaming data rows in the staging table using a plurality of communication channels configured as logically named streaming connections of the database system.

In Example 17, the subject matter of Examples 13-16 includes applying one or more transform operations to the staging table to generate the at least one dynamic table object.

In Example 18, the subject matter of Example 17 includes detecting using the at least one dynamic table object, new streaming data in one or more source tables storing the plurality of streaming data rows.

In Example 19, the subject matter of Example 18 includes performing a refresh of the at least one dynamic table object based on the detection of the new streaming data.

In Example 20, the subject matter of Examples 11-19 includes performing training of a machine learning model using the features in the feature store to generate a trained machine learning model, and processing an inferencing request using the features and the trained machine learning model to generate a prediction associated with the inferencing request.

Example 21 is a computer-storage medium comprising instructions that, when executed by one or more processors of a machine, configure the machine to perform operations comprising decoding raw data received at a database system from a data source to obtain decoded raw data, the decoded raw data comprising streaming data and batch data; performing an incremental computation of features associated with the decoded raw data using an at least one dynamic table object; and pushing the features to a feature store using at least one triggered task.

In Example 22, the subject matter of Example 21 includes the operations further comprising decoding the streaming data as a plurality of streaming data rows received from the data source via a streaming application programming interface (API).

In Example 23, the subject matter of Example 22 includes the operations further comprising ingesting the plurality of streaming data rows in a staging table of the database system using ingestion code of the streaming API; and ingesting the batch data in the staging table from data files, the batch data received via an ingestion pipe of the database system.

In Example 24, the subject matter of Example 23 includes the operations further comprising configuring the streaming API as an API executing at an account of a user of the database system.

In Example 25, the subject matter of Example 24 includes the operations further comprising detecting availability of the streaming data rows at the account of the user of the database system using the streaming API.

In Example 26, the subject matter of Examples 23-25 includes the operations further comprising ingesting the plurality of streaming data rows in the staging table using a plurality of communication channels configured as logically named streaming connections of the database system.

In Example 27, the subject matter of Examples 23-26 includes the operations further comprising applying one or more transform operations to the staging table to generate the at least one dynamic table object.

In Example 28, the subject matter of Example 27 includes the operations further comprising: detecting using the at least one dynamic table object, new streaming data in one or more source tables storing the plurality of streaming data rows.

In Example 29, the subject matter of Example 28 includes the operations further comprising performing a refresh of the at least one dynamic table object based on the detection of the new streaming data.

In Example 30, the subject matter of Examples 21-29 includes the operations further comprising performing training of a machine learning model using the features in the feature store to generate a trained machine learning model, and processing an inferencing request using the features and the trained machine learning model to generate a prediction associated with the inferencing request.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived from there, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
decoding raw data received at a database system from a data source to obtain decoded raw data, the decoded raw data comprising streaming data and batch data;
performing an incremental computation of features associated with the decoded raw data using an at least one dynamic table object; and
pushing the features to a feature store using at least one triggered task.

2. The system of claim 1, the operations further comprising:
decoding the streaming data as a plurality of streaming data rows received from the data source via a streaming application programming interface (API).

3. The system of claim 2, the operations further comprising:
ingesting the plurality of streaming data rows in a staging table of the database system using ingestion code of the streaming API; and
ingesting the batch data in the staging table from data files, the batch data received via an ingestion pipe of the database system.

4. The system of claim 3, the operations further comprising:
configuring the streaming API as an API executing at an account of a user of the database system.

5. The system of claim 4, the operations further comprising:
detecting availability of the streaming data rows at the account of the user of the database system using the streaming API.

6. The system of claim 3, the operations further comprising:
ingesting the plurality of streaming data rows in the staging table using a plurality of communication channels configured as logically named streaming connections of the database system.

7. The system of claim 3, the operations further comprising:
applying one or more transform operations to the staging table to generate the at least one dynamic table object.

8. The system of claim 7, the operations further comprising:
detecting, using the at least one dynamic table object, new streaming data in one or more source tables storing the plurality of streaming data rows.

9. The system of claim 8, the operations further comprising:
performing a refresh of the at least one dynamic table object based on the detecting of the new streaming data.

10. The system of claim 1, the operations further comprising:
performing training of a machine learning model using the features in the feature store, to generate a trained machine learning model; and
processing an inferencing request using the features and the trained machine learning model to generate a prediction associated with the inferencing request.

11. A method comprising:
decoding, by at least one hardware processor, raw data received at a database system from a data source to obtain decoded raw data, the decoded raw data comprising streaming data and batch data;
performing an incremental computation of features associated with the decoded raw data using an at least one dynamic table object; and
pushing the features to a feature store using at least one triggered task.

12. The method of claim 11, further comprising:
decoding the streaming data as a plurality of streaming data rows received from the data source via a streaming application programming interface (API).

13. The method of claim 12, further comprising:
ingesting the plurality of streaming data rows in a staging table of the database system using ingestion code of the streaming API; and
ingesting the batch data in the staging table from data files, the batch data received via an ingestion pipe of the database system.

14. The method of claim 13, further comprising:
configuring the streaming API as an API executing at an account of a user of the database system.

15. The method of claim 14, further comprising:
detecting availability of the streaming data rows at the account of the user of the database system using the streaming API.

16. The method of claim 13, further comprising:
ingesting the plurality of streaming data rows in the staging table using a plurality of communication channels configured as logically named streaming connections of the database system.

17. The method of claim 13, further comprising:
applying one or more transform operations to the staging table to generate the at least one dynamic table object.

18. The method of claim 17, further comprising:
detecting, using the at least one dynamic table object, new streaming data in one or more source tables storing the plurality of streaming data rows.

19. The method of claim 18, further comprising:
performing a refresh of the at least one dynamic table object based on the detecting of the new streaming data.

20. The method of claim 11, further comprising:
performing training of a machine learning model using the features in the feature store, to generate a trained machine learning model; and
processing an inferencing request using the features and the trained machine learning model to generate a prediction associated with the inferencing request.

21. A computer-storage medium comprising instructions that, when executed by one or more processors of a machine, configure the machine to perform operations comprising:
decoding raw data received at a database system from a data source to obtain decoded raw data, the decoded raw data comprising streaming data and batch data;
performing an incremental computation of features associated with the decoded raw data using an at least one dynamic table object; and
pushing the features to a feature store using at least one triggered task.

22. The computer-storage medium of claim 21, the operations further comprising:
decoding the streaming data as a plurality of streaming data rows received from the data source via a streaming application programming interface (API).

23. The computer-storage medium of claim 22, the operations further comprising:
ingesting the plurality of streaming data rows in a staging table of the database system using ingestion code of the streaming API; and
ingesting the batch data in the staging table from data files, the batch data received via an ingestion pipe of the database system.

24. The computer-storage medium of claim 23, the operations further comprising:
configuring the streaming API as an API executing at an account of a user of the database system.

25. The computer-storage medium of claim 24, the operations further comprising:
detecting availability of the streaming data rows at the account of the user of the database system using the streaming API.

26. The computer-storage medium of claim 23, the operations further comprising:
ingesting the plurality of streaming data rows in the staging table using a plurality of communication channels configured as logically named streaming connections of the database system.

27. The computer-storage medium of claim 23, the operations further comprising:
applying one or more transform operations to the staging table to generate the at least one dynamic table object.

28. The computer-storage medium of claim 27, the operations further comprising:
detecting, using the at least one dynamic table object, new streaming data in one or more source tables storing the plurality of streaming data rows.

29. The computer-storage medium of claim 28, the operations further comprising:
performing a refresh of the at least one dynamic table object based on the detecting of the new streaming data.

30. The computer-storage medium of claim 21, the operations further comprising:
performing training of a machine learning model using the features in the feature store, to generate a trained machine learning model; and
processing an inferencing request using the features and the trained machine learning model to generate a prediction associated with the inferencing request.
